(19) United States
(12) Patent Application Publication
(10) Pub. No.: US 2026/0010177 A1
(43) Pub. Date: Jan. 8, 2026

(54) MANAGEMENT SYSTEM, MANAGEMENT METHOD, AND STORAGE MEDIUM

(71) Applicant: HONDA MOTOR CO., LTD., Tokyo (JP)

(72) Inventors: Tetsuya MATSUHISA, Saitama (JP); Koichi TSUNO, Saitama (JP)

(73) Assignee: HONDA MOTOR CO., LTD., Tokyo (JP)

(21) Appl. No.: 19/257,505

(22) Filed: Jul. 2, 2025

(30) Foreign Application Priority Data
Jul. 3, 2024 (JP) 2024-107690

(51) Int. Cl. G05D 1/69; G05D 1/248; G05D 111/30

(52) U.S. Cl. CPC G05D 1/69; G05D 1/248; G05D 2111/30

(57) ABSTRACT

A management system includes a plurality of autonomous mobile machines and an information processing device. Each of the plurality of autonomous mobile machines includes an autonomous movement control unit configured to control an autonomous movement, and a reception unit configured to receive a signal from a satellite in a satellite positioning system. The information processing device includes an operation plan creation unit configured to create an operation plan for the plurality of autonomous mobile machines. The operation plan creation unit is configured to select, as a first autonomous mobile machine, an autonomous mobile machine capable of securing an operation schedule during a first predetermined period from among the plurality of autonomous mobile machines, and create the operation plan such that the first autonomous mobile machine is moved to a predetermined geographical position and stands still for at least a part of the first predetermined period.

This application is based upon and claims the benefit of priority from prior Japanese patent application No. 2024-107690, filed on Jul. 3, 2024, the entire contents of which are incorporated herein by reference.

### TECHNICAL FIELD

The present disclosure relates to a management system, a management method, and a storage medium that perform relative positioning using an autonomous mobile machine.

### BACKGROUND ART

A relative positioning method is a positioning method for acquiring a relative positional relationship between receivers based on signals from a plurality of satellites received by the plurality of receivers. For example, in a real time kinematic global navigation satellite system (RTK-GNSS), positioning is performed using a signal received from a satellite by a base station whose position is known and a mobile station whose position is not known.

The relative positioning method has higher positioning accuracy than an independent positioning method, and is therefore expected to be applied to various industrial fields.

JP2019-33323A discloses a base station device. The base station device includes an integrated unit in which a secondary battery, a power conversion unit that converts power supplied from the secondary battery, a communication unit that performs ad hoc communication with other devices, and a driving unit that autonomously moves the device itself are accommodated in a housing.

JP2016-146010A discloses an operation management system. The operation management system includes a plurality of transport vehicles that travel on a transport path connected to a work area and transport objects to be transported, a resident vehicle that is resident in the work area, a control system that manages the transport vehicles and the resident vehicle, and a wireless relay station that relays wireless communication performed between the transport vehicles and the control system. In the operation management system, a wireless communication device for performing wireless communication with each of the plurality of transport vehicles is disposed. The operation management system includes a wireless relay station in the resident vehicle, and determines a transport vehicle accessing the wireless relay station based on vehicle body information on the transport vehicle.

JP2017-033121A discloses a server device. The server device communicates with a plurality of autonomous traveling device provided with a wireless communication unit via a radio base station, and instructs an operation for each autonomous traveling device. The wireless communication unit of the autonomous traveling device has a relay function of relaying communication with another wireless communication unit provided in another autonomous traveling device different from the radio base station, and transmits position information on the autonomous traveling device and information on a reception strength of the wireless communication radio wave to the server device. The server device includes a communication unit that transmits information indicating an operation to the autonomous traveling device based on the position information and the information on the reception strength so that one of the autonomous traveling devices reaches a destination using the relay function of the other autonomous traveling device when the destination is outside the wireless communication area by the radio base station.

### SUMMARY OF INVENTION

The accuracy of the relative positioning method deteriorates as a distance between a base station whose position is known and a mobile station whose position is not known increases. In addition, providing a plurality of fixed base stations whose positions are known in advance may increase the cost.

Aspects of the present disclosure relates to providing a management system, a management method, and a storage medium that enable highly accurate positioning in a wider range.

According to an aspect of the present disclosure, there is provided a management system including:
a plurality of autonomous mobile machines; and
an information processing device,
in which each of the plurality of autonomous mobile machines includes
   an autonomous movement control unit configured to control an autonomous movement, and
   a reception unit configured to receive a signal from a satellite in a satellite positioning system,
in which the information processing device includes an operation plan creation unit configured to create an operation plan for the plurality of autonomous mobile machines, and
in which the operation plan creation unit is configured to
   select, as a first autonomous mobile machine, an autonomous mobile machine capable of securing an operation schedule during a first predetermined period from among the plurality of autonomous mobile machines, and
   create the operation plan such that the first autonomous mobile machine is moved to a predetermined geographical position and stands still for at least a part of the first predetermined period.

According to another aspect of the present disclosure, there is provided a management method for creating an operation plan for a plurality of autonomous mobile machines each capable of receiving a signal from a satellite in a satellite positioning system, the management method including:
selecting, by a computer, as a first autonomous mobile machine, an autonomous mobile machine capable of securing an operation schedule during a first predetermined period from among the plurality of autonomous mobile machines; and
creating, by the computer, the operation plan such that the first autonomous mobile machine is moved to a predetermined geographical position and stands still for at least a part of the first predetermined period.

According to another aspect of the present disclosure, there is provided a non-transitory computer-readable storage medium storing a management program for creating an operation plan for a plurality of autonomous mobile machines each capable of receiving a signal from a satellite in a satellite positioning system, the management program causing a computer to execute a process including:
selecting, as a first autonomous mobile machine, an autonomous mobile machine capable of securing an operation schedule during a first predetermined period from among the plurality of autonomous mobile machines, and
creating the operation plan such that the first autonomous mobile machine is moved to a predetermined geographical position and stands still for at least a part of the first predetermined period.

According to another aspect of the present disclosure, there is provided a computer readable storage medium storing the above management program.

According to an aspect of the present disclosure, it is possible to perform highly accurate positioning in a wider range.

### BRIEF DESCRIPTION OF DRAWINGS

Exemplary embodiment(s) of the present invention will be described in detail based on the following figures, wherein:

FIG. 1 is a diagram illustrating an overview of a management system 100;

FIG. 2 is a diagram illustrating an example of a hardware configuration of a management device 1;

FIG. 3 is a diagram illustrating an example of a functional block diagram of the management device 1;

FIG. 4 is a diagram illustrating an example of a hardware configuration of an autonomous mobile machine 21;

FIG. 5 is a diagram illustrating an example of a functional block diagram of the autonomous mobile machine 21;

FIGS. 6A and 6B are diagrams illustrating a situation in which the management device 1 selects the autonomous mobile machine 21 as a base station;

FIG. 7 is a diagram illustrating a relationship between a position CP of an antenna 216 and a position of a satellite;

FIG. 8 is a diagram illustrating a surrounding environment of the autonomous mobile machine 21 serving as a base station;

FIG. 9 is a diagram illustrating an overview of positioning according to the present embodiment;

FIG. 10 is a diagram illustrating an example of a processing flow for operating the autonomous mobile machine 21 as a base station;

FIG. 11 is a diagram illustrating an example of a processing flow for creating an operation plan;

FIGS. 12A and 12B are diagrams schematically illustrating processing when one autonomous mobile machine 21 is moved to operate as a base station;

FIGS. 13A, 13B, and 13C are diagrams schematically illustrating processing when two autonomous mobile machines 21 are moved to operate as a base station;

FIG. 14 is a diagram illustrating an example of a processing flow for replacing the autonomous mobile machine 21 as a base station;

FIG. 15 is a diagram illustrating an example of a processing flow for creating a replacement operation plan; and

FIGS. 16A and 16B are diagrams schematically illustrating processing of replacing the autonomous mobile machine 21 as a base station.

### DESCRIPTION OF EMBODIMENTS

Hereinafter, an embodiment according to the present disclosure will be described with reference to the accompanying drawings.

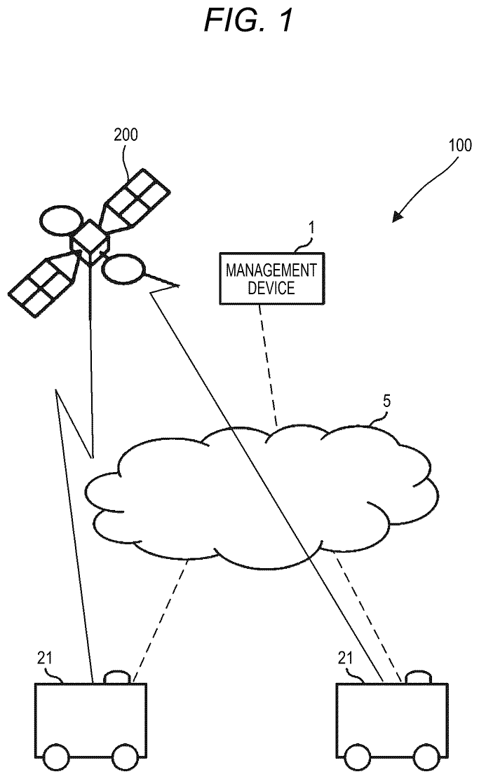

FIG. 1 is a diagram illustrating an overview of a management system 100 according to the embodiment of the present disclosure. The management system according to the present embodiment is a system that includes a management device 1 and a plurality of autonomous mobile machines 21 and performs relative positioning. In the relative positioning, generally, two or more receivers are used, and four or more same GNSS satellites are observed at the same time. Then, a relative positional relationship between two points is obtained by measuring a time difference between when radio signals from the GNSS satellite reach the respective receivers using a position of the GNSS satellite as a reference. The management device 1 and the autonomous mobile machine 21 can communicate with each other via a network 5 such as the Internet. In the example of FIG. 1, the number of autonomous mobile machines is two, but may be three or more.

The autonomous mobile machine 21 is configured to be able to receive signals from the GNSS satellite 200, and the management device 1 can grasp the position of the autonomous mobile machine 21 using RTK-GNSS. The RTK-GNSS is a form of relative positioning in which a signal from the GNSS satellite 200 is observed at the same time at a reference station whose position is known and an observation point whose position is to be obtained, data observed at the reference station is transmitted in real time to the observation point using radio or the like, and the position of the observation point is obtained in real time based on a positional result of the reference station. A fixed base station 10 of RTK-GNSS installed on the ground surface may be provided at a workplace where the autonomous mobile machine 21 operates. Although there are a plurality of (at least four) GNSS satellites 200, only one GNSS satellite 200 is illustrated in FIG. 1 for ease of understanding.

The management device 1 is a device that manages the operation of the autonomous mobile machine 21, and further creates an operation plan of the autonomous mobile machine 21.

Specifically, the management device 1 sets an operation mode in each of the autonomous mobile machines 21, and controls the autonomous mobile machine 21 to operate in accordance with the operation mode. In the present embodiment, the operation mode includes a base station mode and a mobile station mode. In the base station mode, the autonomous mobile machine 21 operates as a base station of RTK-GNSS. In the mobile station mode, the autonomous mobile machine 21 operates as a mobile station of RTK-GNSS. In addition, the management device 1 can receive a signal from the autonomous mobile machine 21 and acquire a current position of the autonomous mobile machine 21, a moving route, a state of the autonomous mobile machine 21, a remaining battery level, the presence or absence of a failure, and the like.

The operation plan includes information such as a movement destination of the autonomous mobile machine 21, a route to the movement destination, a movement start time, and a movement speed. The management device 1 plans the operation plan of the autonomous mobile machine 21 at a predetermined time (for example, before work start).

The management device 1 transmits a movement instruction including information such as the movement destination, the route to the movement destination, the movement start time, the movement speed, and a standstill time to the autonomous mobile machine 21 based on the operation plan.

The autonomous mobile machine 21 is a moving body that is autonomously movable. The autonomous movement is a movement that does not depend on a human operation. The autonomous mobile machine 21 can move in accordance with a program installed in advance, and can also move in accordance with a movement instruction from the management device 1. The autonomous mobile machine 21 may be configured to be movable not only by the autonomous movement but also by the human operation.

The autonomous mobile machine 21 in the base station mode stands still (stops moving) when moving to a position designated by the management device 1, and operate as a base station of RTK-GNSS at the position. When the autonomous mobile machine 21 is neither in the mobile station mode nor in the base station mode, the autonomous mobile machine 21 stands by at a predetermined position of a workplace, for example. The autonomous mobile machine 21 does not move during standby, and does not operate as a base station. For example, the autonomous mobile machine 21 is maintained in a low power activation mode in which a main power supply (ignition) is turned off during standby. The autonomous mobile machine 21 is charged during standby to prepare for start of the next operation according to a predetermined operation plan.

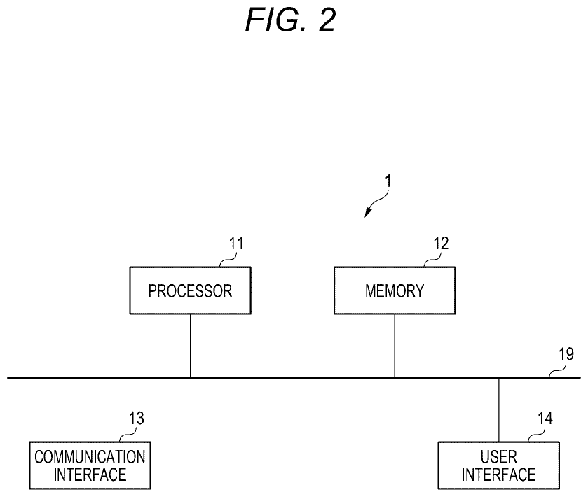

FIG. 2 is a diagram illustrating an example of a hardware configuration of the management device 1. The management device 1 includes a processor 11, a memory 12, a communication interface 13, and a user interface 14. The processor 11, the memory 12, the communication interface 13, and the user interface 14 are connected by, for example, a bus 19.

The processor 11 is a circuit that performs signal processing, and is, for example, a central processing unit (CPU) that performs an overall control of the management device 1. The processor 11 may be implemented by another digital circuit such as a field programmable gate array (FPGA) or a digital signal processor (DSP). The processor 11 may be achieved by combining a plurality of digital circuits.

The memory 12 includes, for example, a main memory and an auxiliary memory. The main memory is, for example, a random access memory (RAM). The main memory is used as a work area of the processor 11.

The auxiliary memory is a non-transitory computer-readable storage medium, and is, for example, a non-volatile memory such as a magnetic disk, an optical disk, or a flash memory. Various program for operating the management device 1 are stored in the auxiliary memory. The programs stored in the auxiliary memory are loaded into the main memory and executed by the processor 11.

The auxiliary memory may include a portable memory removable from the management device 1. The portable memory is, for example, a memory card such as a universal serial bus (USB) flash drive or a secure digital (SD) memory card, or an external hard disk drive.

The communication interface 13 is a communication interface that performs communication with an outside (for example, the autonomous mobile machine 21) of the management device 1. The communication interface 13 is controlled by the processor 11.

The user interface 14 includes, for example, an input device that receives an operation input from a user (for example, a person who operates the management device 1), an output device that outputs information, and the like. The input device is realized by, for example, a pointing device (for example, a mouse), a key (for example, a keyboard), a remote controller, or the like. The output device is realized by, for example, a display or a speaker. Further, both the input device and the output device may be realized by a touch panel or the like. The user interface 14 is controlled by the processor 11.

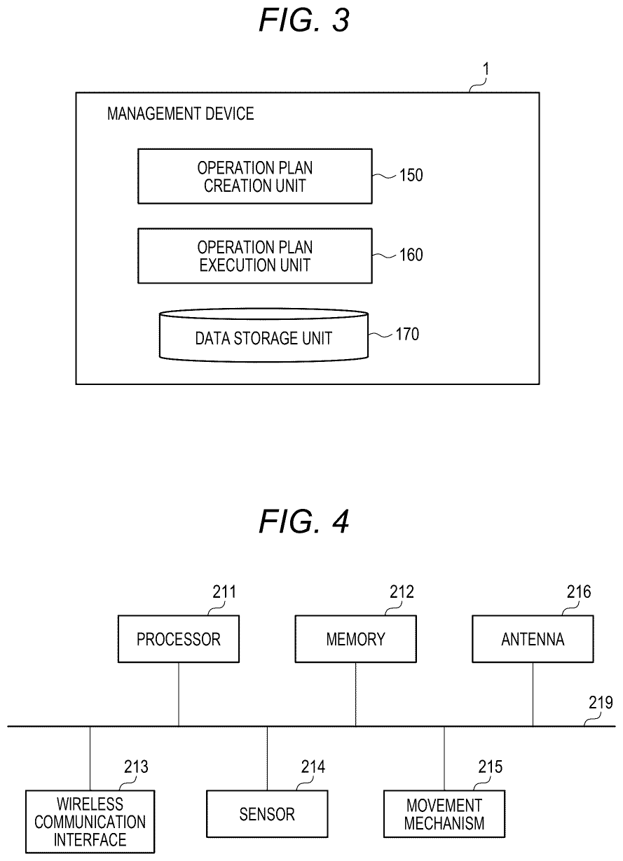

FIG. 3 is a diagram illustrating an example of a functional block diagram of the management device 1. In the management device 1, an operation plan creation unit 150 and an operation plan execution unit 160 are realized by the processor 11 executing a program (software). The operation plan creation unit 150 creates an operation plan of the autonomous mobile machine 21. The operation plan execution unit 160 causes the autonomous mobile machine 21 to execute the operation plan based on the operation plan created by the operation plan creation unit 150. The management device 1 includes a data storage unit 170 implemented by the memory 12.

The operation plan creation unit 150 creates an operation plan such as a movement destination, a route to the movement destination, a movement start time, and a movement speed for the autonomous mobile machine 21 operating in the mobile station mode according to a work task. Examples of the work task include, in addition to a transport task of delivering an object, a monitoring task, a cargo storage task, a mowing task, and a cultivating task.

The operation plan creation unit 150 selects, from among the plurality of autonomous mobile machines 21, the autonomous mobile machine 21 capable of securing an operation schedule during a first predetermined period as the autonomous mobile machine 21 to be operated in the base station mode, and creates the operation plan such that the selected autonomous mobile machine 21 is moved to a predetermined geographical position and stands still for at least a part of the first predetermined period. The first predetermined period is a period including a period during which the autonomous mobile machine 21 is to be operated as a base station. The part of the period may be a time (for example, a time (period) of about 4 hours to 12 hours) necessary for positioning statistical processing to be described later, a time (period) during which the autonomous mobile machine 21 is to be operated as a base station after the positioning statistical processing (after becoming a base station), or a time (period) including these times (periods).

The operation plan creation unit 150 creates an operation plan related to replacement of the autonomous mobile machine 21 operating in the base station mode. That is, the operation plan creation unit 150 selects, from among the plurality of autonomous mobile machines 21, the autonomous mobile machine 21 capable of securing an operation schedule during a second predetermined period after start of the first predetermined period as the autonomous mobile machine 21 to be operated in the base station mode, and creates the operation plan such that the selected autonomous mobile machine 21 is moved to the predetermined geographical position. The second predetermined period is, for example, a remaining period of the first predetermined period or a period including a period newly set as a period during which the autonomous mobile machine 21 is to be operated as a base station.

The operation plan related to the replacement may include a content of keeping the selected autonomous mobile machine 21 still for at least a part of the second predetermined period (for example, a period during which the autonomous mobile machine 21 operates in the base station mode). In addition, a content (for example, a replacement timing) of causing the autonomous mobile machine 21 operating in the base station mode, which is a replacement target, to leave may be included.

When creating the operation plan, the operation plan creation unit 150 performs processing of selecting a candidate site where the selected autonomous mobile machine 21 operates, processing of confirming whether there is a problem in the candidate site specified as the place where the selected autonomous mobile machine 21 operates, and the like.

The operation plan execution unit 160 transmits the movement instruction to the autonomous mobile machine 21 in order to execute the operation plan created by the operation plan creation unit 150, and further transmits an instruction to start the positioning statistical processing to be described later and/or an instruction to transmit correction information to the autonomous mobile machine 21 operating in the base station mode.

The data storage unit 170 stores point cloud data of a workplace, terrain data, data of a list of autonomous mobile machines 21 to be managed, data of an operation plan of each autonomous mobile machine 21, data for specifying a remaining battery level of each autonomous mobile machine 21, data indicating a state of each autonomous mobile machine 21 (for example, in the base station mode, in the mobile station mode, or during standby), and the like.

FIG. 4 illustrates an example of a hardware configuration of the autonomous mobile machine 21. The autonomous mobile machine 21 includes a processor 211, a memory 212, a wireless communication interface 213, a sensor 214, a movement mechanism 215, and an antenna 216. The processor 211, the memory 212, the wireless communication interface 213, the sensor 214, the movement mechanism 215, and the antenna 216 are connected by, for example, a bus 219.

The processor 211 and the memory 212 of the autonomous mobile machine 21 have the same configuration as the processor 11 and the memory 12 of the management device 1, respectively.

The wireless communication interface 213 is a communication interface that performs wireless communication with the outside (for example, the management device 1) of the autonomous mobile machine 21. The wireless communication interface 213 is, for example, a mobile (cellular) communication device, a Wi-Fi (registered trademark) communication device, or the like. The autonomous mobile machine 21 can transmit and receive signals (for example, correction signals SG1 and SG2 to be described later) related to positioning to and from the management device 1 by the wireless communication interface 213. The wireless communication interface 213 is controlled by the processor 211.

The sensor 214 includes various sensor capable of acquiring information on a moving state of the autonomous mobile machine 21, external information, and the like. The sensor 214 is controlled by the processor 11, and sensing data of the sensor 214 is acquired by the processor 11.

The sensor 214 includes, for example, a camera, a light detection and ranging (LiDAR) sensor, a wheel encoder, and an inertial measurement unit (IMU).

The camera is a sensor for acquiring image data. The LiDAR sensor is a three-dimensional sensor for three-dimensionally recognizing the outside of the autonomous mobile machine 21. Specifically, the LiDAR sensor emits a laser beam to measure time until the emitted laser beam hits an object and bounces back and measure a distance and direction to the object. The LiDAR sensor is provided, for example, so as to be able to sense the front of the autonomous mobile machine 21. A plurality of LiDAR sensors may be provided so as to be able to sense a plurality of directions. The LiDAR sensor may be able to perform swinging (panning, tilting), zooming, or the like. The wheel encoder is a sensor that measures a rotation speed of a wheel (wheel speed), and can acquire a vehicle speed of the autonomous mobile machine 21 from a measurement result by the wheel encoder. The IMU is a sensor that measures accelerations in a front-rear direction, a left-right direction, and an upper-lower direction of the autonomous mobile machines 21, and angular velocities in a pitch direction, a roll direction, and a yaw direction.

The movement mechanism 215 is a mechanism for the autonomous mobile machine 21 to autonomously move. The movement mechanism 215 is, for example, a wheel or a leg for walking. The movement mechanism 215 is controlled by the processor 211. In the following example, it is assumed that the movement mechanism 215 is a wheel. Although not shown, the autonomous mobile machine 21 includes an actuator such as a motor unit, and moves by driving the movement mechanism 215 by the actuator.

The antenna 216 is an antenna for receiving the signal from the GNSS satellite 200. A communication module (not illustrated) receives a signal transmitted from an artificial satellite via the antenna 216, and the communication module can calculate the position information. The calculated position information is processed by the processor 211, or is transmitted to the management device 1 via the wireless communication interface 213.

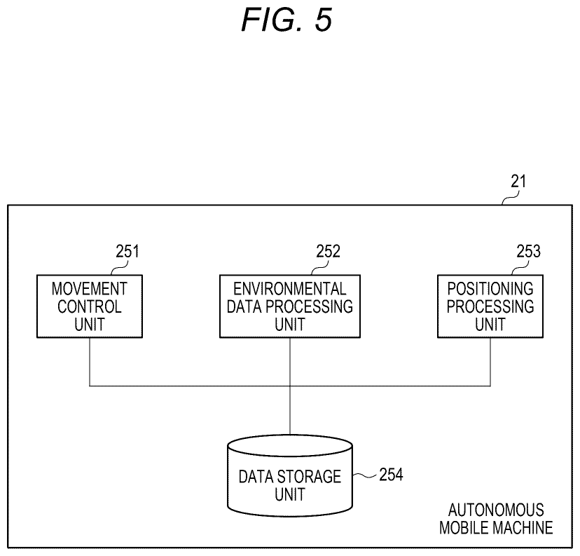

FIG. 5 illustrates an example of a functional block diagram of the autonomous mobile machine 21. In the autonomous mobile machine 21, as illustrated in FIG. 5, a movement control unit 251, an environmental data processing unit 252, and a positioning processing unit 253 are realized by the processor 211 executing a program (software). A data storage unit 254 is implemented in the memory 212.

The movement control unit 251 executes processing of controlling a movement of the autonomous mobile machine 21 based on the data stored in the data storage unit 254.

The environmental data processing unit 252 executes processing of transmitting data acquired by the sensor 214, which is stored in the data storage unit 254, to the management device 1.

The positioning processing unit 253 executes processing of positioning RTK-GNSS based on the data stored in the data storage unit 254.

The data storage unit 254 stores information on a work task, information on a mode of the own device, data acquired by the sensor 214, data acquired by the antenna 216, and the like.

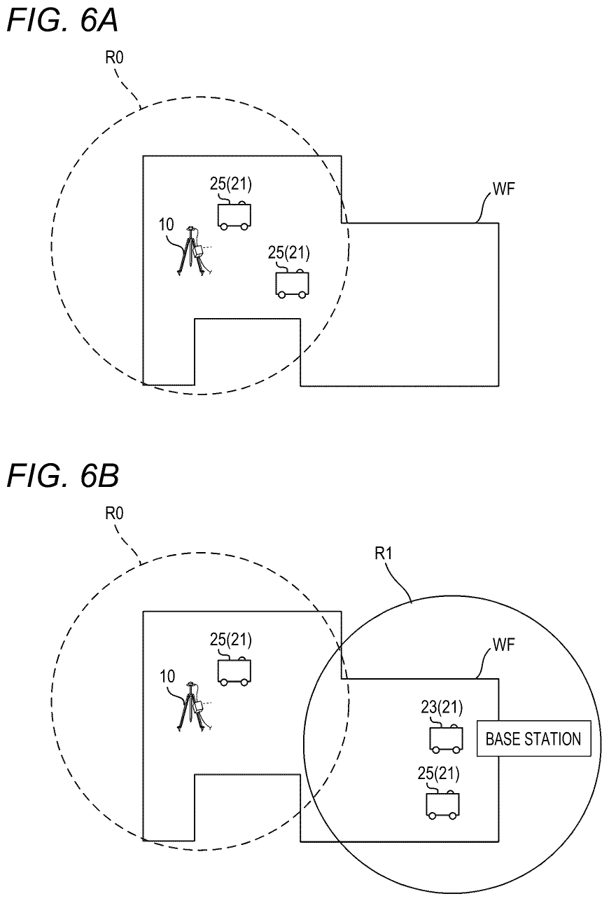

Next, a situation in which the management device 1 selects the autonomous mobile machine 21 as a base station will be described. FIGS. 6A and 6B are diagrams illustrating the situation in which the management device 1 selects the autonomous mobile machine 21 as a base station. Here, when the plurality of autonomous mobile machines 21 work in a workplace WF, it is assumed that there is one fixed base station 10 in the workplace WF. Examples of the workplace WF include a construction site, a farm, and a harbor.

An area that the fixed base station 10 can cover when operating as a base station is defined as an area R0. The fixed base station 10 may be installed at a place where absolute position information (true latitude and longitude) is already known, and it is assumed that the absolute position information is acquired in advance by positioning statistical processing or the like to be described later.

The concept of the area that the fixed base station 10 can cover is an area in which the position information obtained by receiving the signal from the GNSS satellite 200 can be corrected with the same correction information, and is determined according to the application. This definition also applies to an area (hereinafter referred to as R1) that can be covered when the autonomous mobile machine 21 operates as a base station. The area is, for example, an area having a radius of 10 km from the base station in an application requiring highly accurate positioning, and is, for example, an area having a radius of 100 km from the base station in an application requiring not so highly accurate positioning.

In the following description, when distinguishing between the autonomous mobile machine 21 operating in the base station mode and the autonomous mobile machine 21 operating in the mobile station mode, the former is referred to as a selected mobile machine 23, and the latter is referred to as a work mobile machine 25.

As illustrated in FIG. 6A, when the work task of the work mobile machine 25 is completed in the area R0 of the fixed base station 10, the work mobile machine 25 can perform accurate positioning with the correction information from the fixed base station 10 and can carry out the work task. On the other hand, as illustrated in FIG. 6B, when the work task of the work mobile machine 25 includes an area outside the area R0 of the fixed base station 10, the work mobile machine 25 outside the area R0 cannot perform accurate positioning with the correction information from the fixed base station 10. Therefore, the selected mobile machine 23 is moved and operated as a base station so that an area R1 of the selected mobile machine 23 includes a work area of the work mobile machine 25. Accordingly, even when the work area of the work mobile machine 25 is outside the area R0 of the fixed base station 10, accurate positioning can be performed with the correction information from the selected mobile machine 23 as long as the work area is within the area R1 of the selected mobile machine 23.

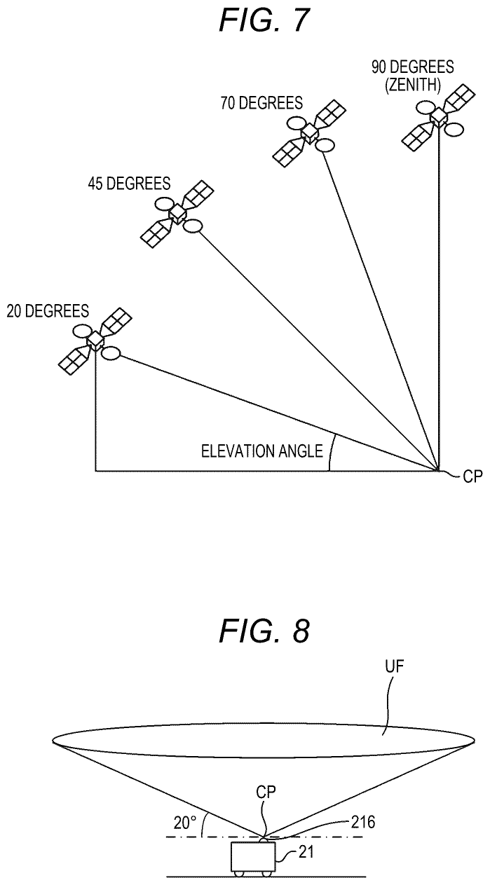

As the place where the selected mobile machine 23 is moved and stand still, a place where no obstacles block the signal from the GNSS satellite 200 to the autonomous mobile machine 21 is selected. In selecting a place where no obstacles block the signal from the satellite to the autonomous mobile machine 21, an elevation angle is considered as one example. FIG. 7 is a diagram illustrating a relationship between a position CP of the antenna 216 of the autonomous mobile machine 21 and a position of the satellite. For example, a place where there is no or relatively few obstacles such as buildings and trees at an elevation angle of 30 degrees or more around the position CP of the antenna 216 is specified. In this case, for example, the condition may be that the number of obstacles having a predetermined elevation angle of 360 degrees or more around the position CP of the antenna 216 is equal to or less than a predetermined number, or that an area (volume) occupied by the obstacles having a predetermined elevation angle of 360 degrees or more around the position CP of the antenna 216 is equal to or less than a predetermined value. An elevation angle of 20 degrees or more may be used as a more strict criterion. Further, inclination of the ground surface may be used as a specific condition of the place.

FIG. 8 is a diagram illustrating a surrounding environment of the autonomous mobile machine 21 serving as a base station.

For example, under the condition that there is no obstacles such as buildings or trees at an elevation angle of 20 degrees or more, as illustrated in FIG. 8, an area UF having an inverted triangular pyramid shape at an elevation angle of 20 degrees is monitored from the position CP of the antenna 216. In order to reduce obstacles, the position CP of the antenna 216 is preferably high, and for example, the antenna 216 is preferably installed at 2 m or more above the ground surface.

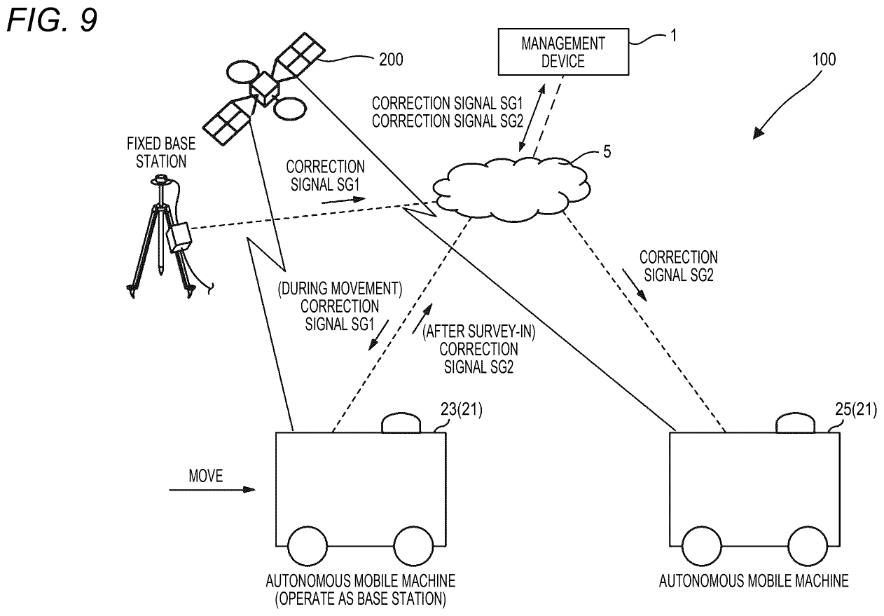

FIG. 9 is a diagram illustrating an overview of positioning in the present embodiment. As illustrated in FIG. 6B, when the selected mobile machine 23 is moved to a specified position outside the area R0 (hereinafter referred to as a specified site) and operated as a base station, the position of the selected mobile machine 23 can be specified using the correction signal SG1 sent by the fixed base station 10 when the selected mobile machine 23 is moved. That is, the fixed base station 10 has absolute position information (true latitude and longitude) of the place where the fixed base station 10 is installed, and calculates an offset amount of the signal from the GNSS satellite 200 by receiving the signal from the GNSS satellite 200 and comparing the signal with the absolute position information. Then, the offset amount is transmitted to the management device 1 as the correction signal SG1, and the management device 1 transmits the correction signal SG1 to the selected mobile machine 23. The selected mobile machine 23 can accurately acquire position information on the autonomous mobile machine 21 by correcting the position information obtained by receiving the signal from the GNSS satellite 200 based on the correction signal SG1. The generation of the correction signal SG1 is not limited to the case of being performed by the fixed base station 10, and may be performed by the management device 1, or may be performed by the selected mobile machine 23 as a receiver.

The selected mobile machine 23 stands still after moving to the specified site, self-measures a signal from the GNSS satellite 200 by independent positioning, and performs the statistical processing (calibration) for acquiring absolute position information (true latitude and longitude) on the selected mobile machine 23. Hereinafter, this processing is referred to as positioning statistical processing (survey-in). The positioning statistical processing takes, for example, about 4 hours to 12 hours. The selected mobile machine 23 can acquire the absolute position information of the standstill position by statistically processing the signal from the GNSS satellite 200 by the positioning statistical processing. In the positioning statistical processing, when there is a time in which the surrounding environment is not suitable for the statistical processing from the start to the end, it is possible to improve statistical processing accuracy by excluding data of the time.

The selected mobile machine 23 calculates the offset amount of the signal from the GNSS satellite 200 at the specified site by comparing the absolute position information acquired by the positioning statistical processing with the signal from the GNSS satellite 200 received at the specified site, and transmits the offset amount to the management device 1 as the correction signal SG2. By receiving the correction signal SG2 from the management device 1, the work mobile machine 25 can accurately specify the position of the work mobile machine 25 using the correction signal SG2. Accordingly, the management device 1 can realize a safe operation and a remote control in the workplace by the position information with high accuracy.

After starting the positioning statistical processing, the selected mobile machine 23 does not move as long as it is in a base station mode in which it operates as a base station. That is, the selected mobile machine 23 maintains a standstill state as long as the selected mobile machine 23 is in the base station mode and sending the correction signal SG2 even when the positioning statistical processing is completed. Since the signal from the GNSS satellite 200 varies depending on the weather, the surrounding environment, and the like, the correction signal SG2 also changes over time. Therefore, the selected mobile machine 23 constantly sends the correction signal SG2, and the work mobile machine 25 constantly receives the correction signal SG2.

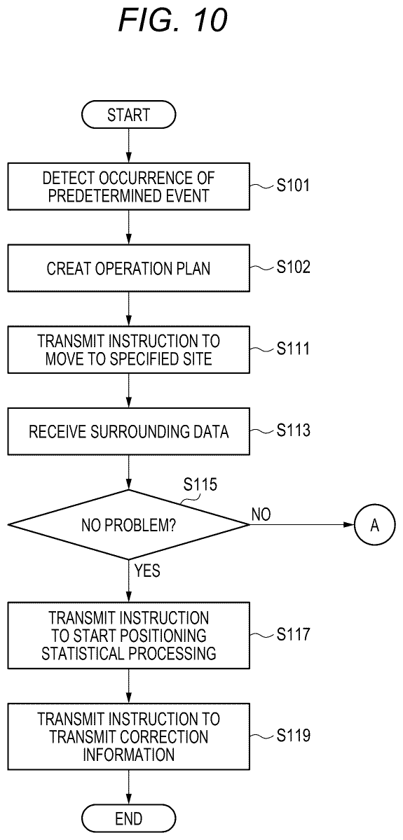

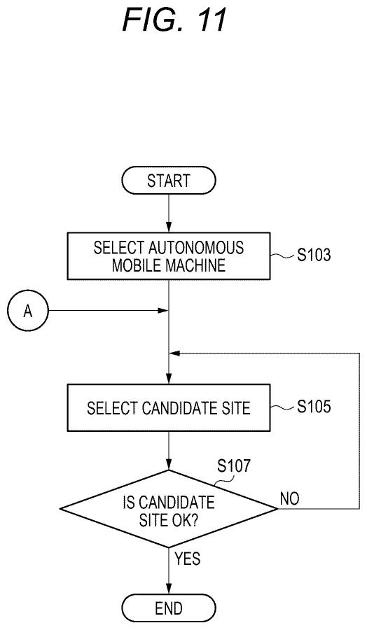

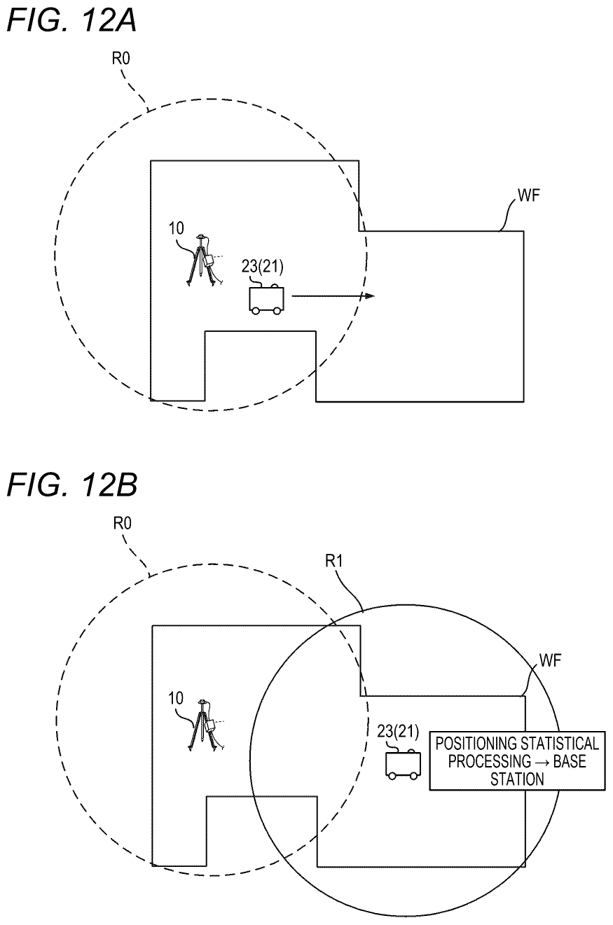

FIG. 10 is a diagram illustrating an example of a processing flow for operating the autonomous mobile machine 21 during standby as a base station, FIG. 11 is a diagram illustrating an example of a processing flow for creating an operation plan, and FIGS. 12A and 12B are diagrams schematically illustrating processing when one selected mobile machine 23 is moved to operate as a base station.

As illustrated in FIG. 10, the operation plan creation unit 150 of the management device 1 detects occurrence of a predetermined event (step S101). The predetermined event is, for example, (1) an event in which a work task outside the area R0 cover by the fixed base station 10 is set, (2) an event in which the fixed base station 10 goes down (that is, the fixed base station 10 cannot operate), or (3) an event in which an instruction to perform operation without installing a fixed base station 10 is input from the user. Based on the occurrence of the predetermined event, the operation plan creation unit 150 can grasp an area and a period where the autonomous mobile machine 21 is to be operated as a base station.

The operation plan creation unit 150 creates the operation plan based on the generated predetermined event (step S102).

More specifically describing creation processing of the operation plan with reference to FIG. 11, the operation plan creation unit 150 selects one autonomous mobile machine that is on standby (that is, not scheduled to operate) during the first predetermined period based on data of the operation plan stored in the data storage unit 170 (step S103).

The operation plan creation unit 150 selects one candidate site for a place where the selected mobile machine 23 operates as a base station from the workplace WF, based on the point cloud data stored in the data storage unit 170 (step S105). In step S105, for example, as described above, a place where no obstacles block the signal from the GNSS satellite 200 to the selected mobile machine 23 is selected.

The operation plan creation unit 150 presents the selected candidate site to the user. Then, the operation plan creation unit 150 determines whether OK is input from the user (that is, whether the user has approved the specified candidate site) (step S107). When the user cannot input OK to the management device 1, or when the user inputs in advance that the processing of step S107 may be skipped, the processing of step S107 may be skipped.

When OK is not input from the user (step S107: NO), the operation plan creation unit 150 returns the process to step S105 in order to specify another candidate site. On the other hand, when OK is input from the user (step S107: YES), the creation processing of the operation plan ends. When the candidate site is reselected, the user may manually input the candidate site. Hereinafter, the candidate site specified in step S107 is referred to as a specified site.

Returning to FIG. 10, when the operation plan is created, the operation plan execution unit 160 transmits the movement instruction to the specified site to the selected mobile machine 23 as illustrated in FIG. 12A (step S111). When receiving the movement instruction, the selected mobile machine 23 moves to the specified site by the movement mechanism 215.

When the selected mobile machine 23 moves to the specified site, the environmental data processing unit 252 of the selected mobile machine 23 acquires data of the environment around the selected mobile machine 23 (hereinafter referred to as surrounding environment data). The surrounding environment data includes, for example, image data acquired by the camera and data acquired by the LiDAR. The environmental data processing unit 252 of the selected mobile machine 23 transmits the acquired surrounding environment data to the management device 1, and the operation plan creation unit 150 receives the surrounding environment data (step S113). When the camera of the selected mobile machine 23 is mounted only on a front side and cannot capture a rearward image, the selected mobile machine 23 may acquire the surrounding environment data by, for example, traveling around a vicinity of the specified site.

The operation plan creation unit 150 determines whether there is no problem in the surrounding environment of the specified site based on the received surrounding environment data (step S115). When there is a problem in the surrounding environment of the specified site (for example, there is an obstacle in the surroundings) (step S115: NO), the processing returns to step S105 of the creation processing of the operation plan, the candidate site is reselected, and the operation plan is created again. Although the candidate site is selected using the point cloud data in the processing of step S105, there may be an obstacle not reflected in the point cloud data or there may be another problem in the surrounding environment after the fact, and thus the processing of steps S113 and S115 is executed. In addition to the processing of steps S113 and S115, processing of checking a reception state of the signal from the GNSS satellite 200 may be executed.

On the other hand, when there is no problem in the surrounding environment (step S115: YES), the operation plan execution unit 160 transmits an instruction to change to the base station mode and an instruction to start the positioning statistical processing (survey-in) to the selected mobile machine 23 as illustrated in FIG. 12B (step S117). After completing the positioning statistical processing, the operation plan execution unit 160 transmits an instruction to transmit the correction signal SG2 to the selected mobile machine 23 (step S119).

In this way, the selected mobile machine 23 starts operating as a base station. When the selected mobile machine 23 sends the correction signal SG2 in the base station mode, the management device 1 can accurately specify the position of the work mobile machine 25 using the correction signal SG2. Accordingly, it is possible to realize a safe operation and a remote control in the workplace WF by the position information with high accuracy.

In addition, even outside the area RO of the fixed base station 10 as described above, it is possible to dynamically expand a workable area according to work needs.

Although the installation of the fixed base station 10 requires a relatively large cost, the cost can be reduced by operating the autonomous mobile machine 21 as a base station. Further, the cost for maintenance can also be reduced. The autonomous mobile machine 21 may be equipped with the wireless communication interface 213, the antenna 216, and the battery as a base station unit that can be attached to and detached from the autonomous mobile machine 21, and the base station unit may be installed after moving to a specified site.

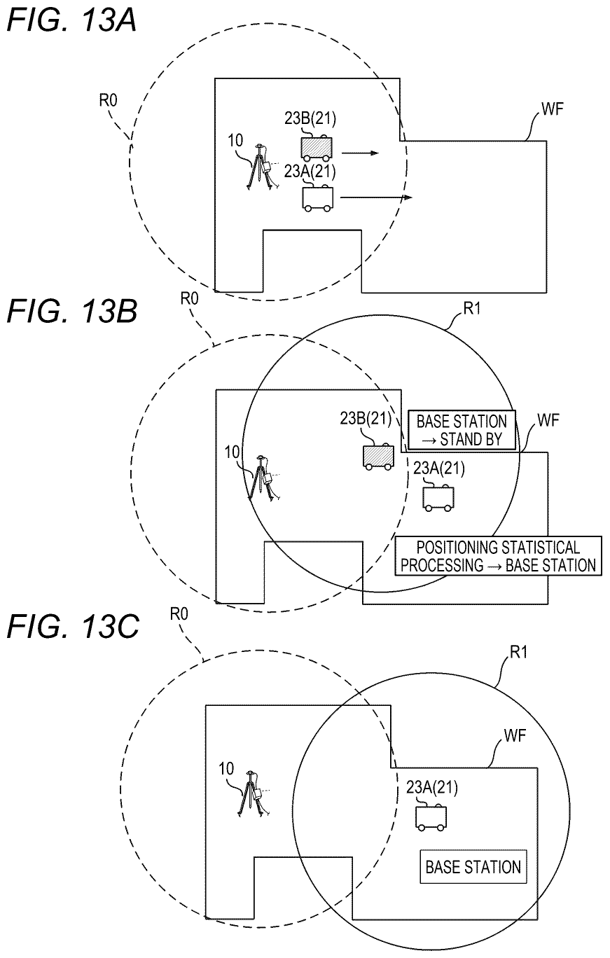

In FIGS. 10 to 12B, the processing has been exemplified in the case where one autonomous mobile machine 21 is moved to operate as a base station, but the present disclosure is not limited thereto, and two autonomous mobile machines 21 may be moved. FIGS. 13A, 13B and 13C are diagrams schematically illustrating processing when two selected mobile machines 23 are moved to operate as a base station.

In this case, based on the data of the operation plan stored in the data storage unit 170, the operation plan creation unit 150 selects two autonomous mobile machines 21 that is on standby (that is, not scheduled to operate) during a target period, and transmits a movement instruction to move to the specified site to the two selected mobile machines 23 as illustrated in FIG. 13A. Hereinafter, one selected mobile machine 23 is referred to as a first selected mobile machine 23A, and the other selected mobile machine 23 is referred to as a second selected mobile machine 23B.

Then, as illustrated in FIG. 13B, the first selected mobile machine 23A is instructed to start the positioning statistical processing (survey-in) at the first specified site, and the second selected mobile machine 23B is instructed to send the correction signal SG2 as a base station at the second specified site. Accordingly, the work mobile machine 25 can perform the work task outside the area R0 of the fixed base station 10 without waiting for the completion of the positioning statistical processing of the first selected mobile machine 23A. It is preferable that a first specified site and a second specified site are overlapping areas of the areas R1.

In the example of FIG. 13B, the second specified site is within the area R0 of the fixed base station 10. When the second specified site is within the area R0 of the fixed base station 10, the position of the second selected mobile machine 23B can be accurately specified using the correction signal SG1 from the fixed base station 10, and the position of the work mobile machine 25 can also be accurately specified using the correction signal SG2 from the second selected mobile machine 23B. However, the second specified site may be outside the area R0. Even when the second specified site is outside the area R0 of the fixed base station 10, it is possible to specify the position with higher accuracy than when the work mobile machine 25 performs the independent positioning.

Then, as illustrated in FIG. 13C, by moving by the two selected mobile machines 23, in step S113 of FIG. 10, a camera of the first selected mobile machine 23A can acquire surrounding environment data of the second selected mobile machine 23B, and conversely, a camera of the second selected mobile machine 23B can acquire surrounding environment data of the first selected mobile machine 23A.

After completing the positioning statistical processing, the first selected mobile machine 23A starts operating as a base station. Accordingly, since the work mobile machine 25 can use the correction signal SG2 of the first selected mobile machine 23A having accurate position information (absolute position information) in a wider range, the management device 1 can accurately specify the position of the work mobile machine 25. The second selected mobile machine 23B is a temporary base station until the positioning statistical processing of the first selected mobile machine 23A is completed, and ends the base station mode after the first selected mobile machine 23A completes the positioning statistical processing and is instructed to stand by at a predetermined place. When it is preferable to leave the second selected mobile machine 23B as a base station rather than to leave the first selected mobile machine 23A as a base station, for example, in a case where the remaining battery level of the first selected mobile machine 23A is low, the first selected mobile machine 23A may be caused to stand by at a predetermined place after the positioning statistical processing is completed, the second selected mobile machine 23B may be moved to the first specified site which is a place where the positioning statistical processing is performed by the first selected mobile machine 23A, and the second selected mobile machine 23B may be caused to operate as a base station.

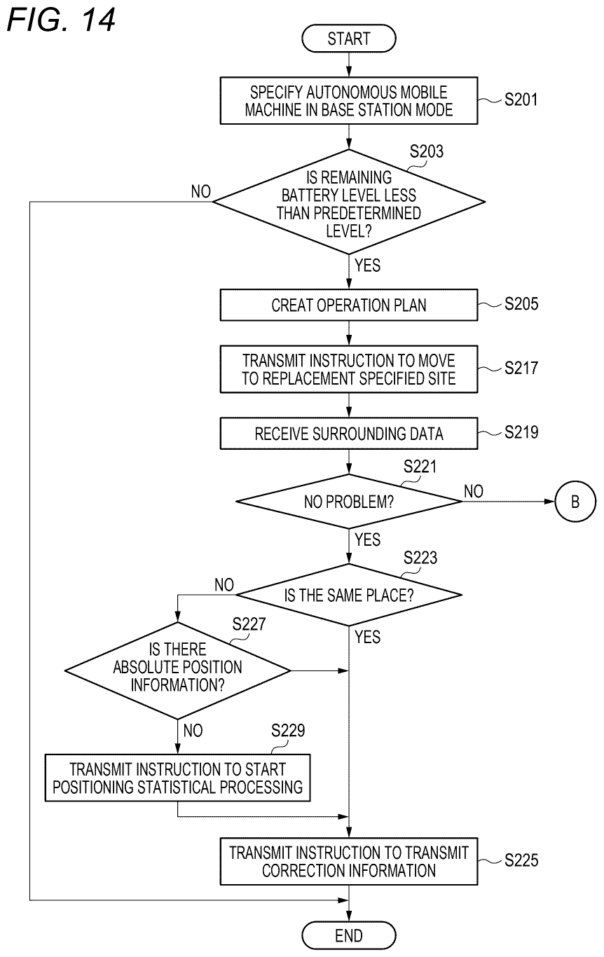

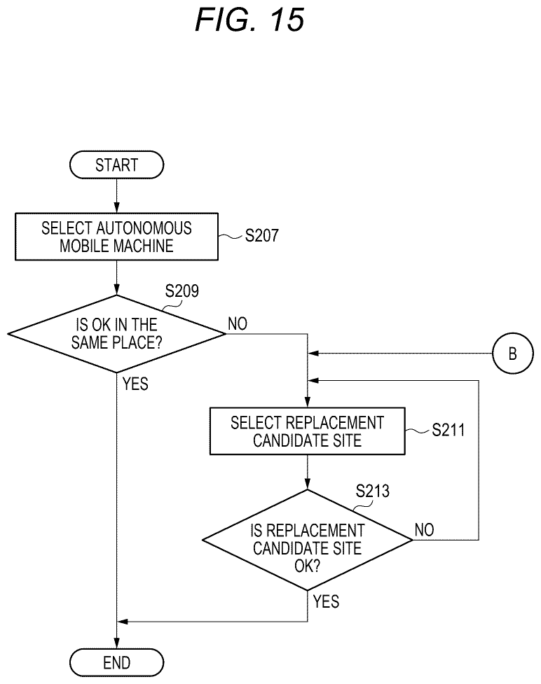

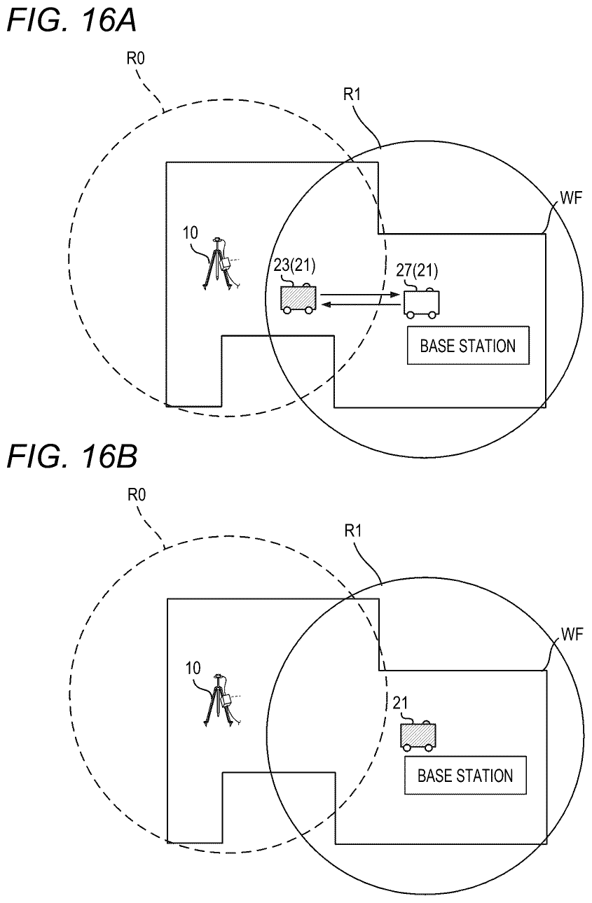

Next, processing of replacing the autonomous mobile machine 21 as a base station will be described. FIG. 14 is a diagram illustrating an example of a processing flow for replacing the autonomous mobile machine 21 as a base station, FIG. 15 is a diagram illustrating an example of a processing flow for creating a replacement operation plan, and FIGS. 16A and 16B are diagrams schematically illustrating processing for replacing the autonomous mobile machine 21 as a base station.

As illustrated in FIG. 14, based on mode management data stored in the data storage unit 170, the operation plan creation unit 150 of the management device 1 specifies the autonomous mobile machine 21 that is in the base station mode (that is, operating as a base station) in the workplace WF (step S201). Hereinafter, the autonomous mobile machine 21 specified in step S201 is referred to as a specified mobile machine 27.

The operation plan creation unit 150 determines whether the remaining battery level of the specified mobile machine 27 is less than a predetermined level (step S203). The information on the remaining battery level may be periodically provided from the selected mobile machine 23, or may be calculated based on the remaining battery level at the start of the base station mode and the time elapsed from the start.

When the remaining battery level is not less than the predetermined level (step S203: NO), since it is not necessary to replace the specified mobile machine 27, the process ends. On the other hand, when the remaining battery level is less than the predetermined level (step S203: YES), the operation plan creation unit 150 creates an operation plan related to replacement of the specified mobile machine 27 operating with a base station (step S205).

More specifically describing the creation processing of the operation plan related to replacement with reference to FIG. 15, the operation plan creation unit 150 selects the autonomous mobile machine 21 that operates as a base station instead of the specified mobile machine 27 (step S207). Specifically, based on the data of the operation plan stored in the data storage unit 170, the operation plan creation unit 150 selects one autonomous mobile machine that is on standby (that is, not scheduled to operate) during the second predetermined period. Hereinafter, the autonomous mobile machine 21 selected in step S207 is referred to as the selected mobile machine 23.

Subsequently, the operation plan creation unit 150 selects a movement destination of the selected mobile machine 23. Specifically, the operation plan creation unit 150 determines whether the movement destination of the selected mobile machine 23 is the same place as the place where the specified mobile machine 27 is present with reference to the point cloud data or the like of the workplace WF (step S209).

When there is a failure in the function as a base station in the same place (step S209: NO) such as a case where a problem occurs in the surrounding environment afterwards or a case where a new inhibition condition occurs, the operation plan creation unit 150 selects one candidate site for a place where the specified mobile machine 27 operates as a base station (hereinafter, also referred to as a replacement candidate site) from the workplace WF based on the point cloud data stored in the data storage unit 170 in order to select another candidate site (step S211). A selection condition of the replacement candidate site is as described in FIGS. 7 and 8. The operation plan creation unit 150 presents the replacement candidate site to the user.

Then, the operation plan creation unit 150 determines whether OK is input from the user (that is, whether the user has approved the replacement candidate site) (step S213). When the user cannot input OK to the management device 1, or when the user inputs in advance that the processing of step S213 may be skipped, the processing of step S213 may be skipped.

When OK is not input from the user (step S213: NO), the operation plan creation unit 150 returns the process to step S211 in order to select the other replacement candidate site. On the other hand, when there is no problem in the same place in step S209, the operation plan creation unit 150 creates the operation plan with the same place as the replacement candidate site, and ends the creation processing of the operation plan. In addition, in step S213, when OK is input from the user (steps S209 and S213: YES), the operation plan is created with the other newly selected place as the replacement candidate site, and the creation processing of the operation plan ends. When the replacement candidate site is reselected, the user may manually input the replacement candidate site. Hereinafter, the candidate site specified in steps S209 and S213 is referred to as a replacement specified site.

Returning to FIG. 14, when the operation plan is created, the operation plan execution unit 160 transmits an instruction to move to the replacement specified site to the selected mobile machine 23 as illustrated in FIG. 16A (step S217). When receiving the movement instruction, the selected mobile machine 23 moves to the replacement specified site by the movement mechanism 215 as illustrated in FIG. 16B.

When the selected mobile machine 23 moves to the replacement specified site, the environment data processing unit 252 of the selected mobile machine 23 acquires the surrounding environment data of the selected mobile machine 23. The environmental data processing unit 252 of the selected mobile machine 23 transmits the acquired surrounding environment data to the management device 1, and the operation plan creation unit 150 receives the surrounding environment data (step S219). For example, when the camera of the selected mobile machine 23 is mounted only on the front side and cannot capture a rearward image, the selected mobile machine 23 may acquire the image by, for example, traveling around a vicinity of the specified candidate site. When the replacement specified site is the same place as the place where the specified mobile machine 27 is present, the surrounding environment data may be acquired from the specified mobile machine 27.

The operation plan creation unit 150 determines whether there is no problem in the surrounding environment based on the received surrounding environment data (step S221). When there is a problem in the surrounding environment (for example, there is an obstacle in the surroundings) (step S221: NO), the processing returns to step S211 of the creation processing of the operation plan, and the operation plan is created again. Although the replacement candidate site is specified using the point cloud data in the process of step S211, there may be an obstacle not reflected in the point cloud data or there may be another problem in the surrounding environment in the place where the specified mobile machine 27 is present after the fact, and thus the processing of step S221 is executed. In addition to the processing of step S221, processing of checking a reception state of the signal from the GNSS satellite 200 may be executed.

On the other hand, when there is no problem in the surrounding environment (step S221: YES), the operation plan execution unit 160 determines whether the replacement specified site is the same place as the place where the specified mobile machine 27 is present, and when the replacement specified site is the same place (step S223: YES), since the absolute position information already exists, the operation plan execution unit 160 transmits, to the selected mobile machine 23, the instruction to change to the base station mode and the instruction to transmit the correction signal SG2 (step S225).

In step S223, when the place is not the same as the place where the specified mobile machine 27 is present (step S223: NO), the operation plan execution unit 160 confirms the presence or absence of absolute position information on the place (step S227). When the absolute position information is already present in step S227, for example, when the place is a place where the positioning data exists by performing the positioning statistical processing in the past (step S227: YES), the operation plan execution unit 160 transmits, to the selected mobile machine 23, the instruction to change to the base station mode and the instruction to transmit the correction signal SG2 (step S225).

On the other hand, when there is no absolute position information in step S227 (step S227: NO), for example, when the specified candidate site is unexplored, the operation plan execution unit 160 transmits an instruction to start positioning statistical processing (survey-in) to the selected mobile machine 23 (step S229). After completing the positioning statistical processing, the operation plan execution unit 160 transmits, to the selected mobile machine 23, the instruction to change to the base station mode and the instruction to transmit the correction signal SG2 (step S225).

By performing the processing described above, even when the autonomous mobile machine 21 having a battery restriction is used as the base station, it is possible to prevent the base station from stopping operation during execution of the work task. In the flow described above, the necessity of replacement is determined based on the remaining battery level of the autonomous mobile machine 21 as a base station, but the present disclosure is not limited thereto, and the necessity of replacement may be determined based on an operation state of the autonomous mobile machine 21 as a base station, for example, the presence or absence of a failure, or the necessity of replacement may be determined based on the presence or absence of a change in the operation plan of the autonomous mobile machine 21 as a base station.

Although the various embodiments have been described above with reference to the drawings, it is needless to say that the present disclosure is not limited to these examples. It is apparent that those skilled in the art can conceive of various modifications and changes within the scope described in the claims, and it is understood that such modifications and changes naturally fall within the technical scope of the present disclosure. In addition, constituent elements in the embodiment described above may be freely combined without departing from the gist of the present disclosure.

Note that the positioning method is not limited to RTK-GNSS. It is also possible to use another relative positioning method using a base station (or a reference point).

A charger that charges the autonomous mobile machine 21 is provided in the workplace WF, and the autonomous mobile machine 21 can be operated as a base station during charging by grasping absolute position information of an installation place of the charger in advance. In addition, since a headquarters base is provided in the workplace WF and the fixed base station 10 is installed at the headquarters base, for example, when the autonomous mobile machine 21 is used for a transport work at the construction site, the area R0 covered by the fixed base station 10 can be fluidly set by moving the headquarters base according to the progress of the construction work. In addition, a standby site where the autonomous mobile machine 21 stands by and a charging site where a charger is arranged may be provided together. By charging the autonomous mobile machine 21 while the autonomous mobile machine 21 is on standby, the autonomous mobile machine 21 can be efficiently used.

The management device 1 may be a server device installed at a headquarters base or another site, a distributed server including a plurality of server devices, or a distributed virtual server (cloud server) created in a cloud environment. In addition, at least one autonomous mobile machine 21 among the autonomous mobile machines 21 may be set as a master mobile machine and the other autonomous mobile machines 21 may be set as slave mobile machines, and the master mobile machine may have a function of the management device 1.

The management method described in the above embodiment can be implemented by executing a control program prepared in advance on a computer. The control program is stored in a computer-readable storage medium and executed by being read from the storage medium. Further, the control program may be provided in a form stored in a non-transitory storage medium such as a flash memory, or may be provided via a network such as the Internet.

In the present specification, at least the following matters are described. Although corresponding constituent elements or the like in the embodiment described above are shown in parentheses, the present disclosure is not limited thereto.

(1) A management system (management system 100) including:
a plurality of autonomous mobile machines (autonomous mobile machine 21); and
an information processing device (management device 1),
in which each of the plurality of autonomous mobile machines includes
   an autonomous movement control unit (movement control unit 251) configured to control an autonomous movement, and
   a reception unit (antenna 216) configured to receive a signal from a satellite (GNSS satellite 200) in a satellite positioning system,
in which the information processing device includes an operation plan creation unit (operation plan creation unit 150) configured to create an operation plan for the plurality of autonomous mobile machines, and
in which the operation plan creation unit is configured to
   select, as a first autonomous mobile machine (selected mobile machine 23), an autonomous mobile machine capable of securing an operation schedule during a first predetermined period from among the plurality of autonomous mobile machines, and
   create the operation plan such that the first autonomous mobile machine is moved to a predetermined geographical position and stands still for at least a part of the first predetermined period.

According to (1), since the autonomous mobile machine that is not scheduled to operate can operate as a base station, an area in which positioning can be performed can be set more flexibly. Accordingly, it is possible to perform highly accurate positioning in a wider range.

(2) The management system according to (1),
in which the operation plan creation unit is configured to
   select, as a second autonomous mobile machine (selected mobile machine 23), an autonomous mobile machine capable of securing an operation schedule during a second predetermined period after start of the first predetermined period from among the plurality of autonomous mobile machines, and
   create the operation plan such that the second autonomous mobile machine is moved to the predetermined geographical position.

(3) The management system according to (2),
in which the operation plan creation unit is configured to create the operation plan such that the second autonomous mobile machine is moved to the predetermined geographical position and stands still for at least a part of the second predetermined period.

According to (2), the second autonomous mobile machine can take over a function of the first autonomous mobile machine as a base station.

According to (3), the second autonomous mobile machine can take over the function of the first autonomous mobile machine as a base station.

(4) The management system according to (2) or (3),
in which the operation plan creation unit creates the operation plan such that the second autonomous mobile machine is moved to the predetermined geographical position and the first autonomous mobile machine (specified mobile machine 27) makes leaving from the predetermined geographical position.

According to (4), after the second autonomous mobile machine takes over the function as a base station, the first autonomous mobile machine can be moved.

(5) The management system according to (4),
in which the operation plan creation unit determines the leaving of the first autonomous mobile machine based on a remaining battery level of the first autonomous mobile machine.

According to (5), it is possible to avoid loss of function as a base station due to insufficient remaining battery level by determining the leaving of the autonomous mobile machine functioning as a base station according to the remaining battery level.

(6) The management system according to (4),
in which the operation plan creation unit determines the leaving of the first autonomous mobile machine based on an operation state of the first autonomous mobile machine.

According to (6), it is possible to avoid the loss of the function as a base station due to a failure of the autonomous mobile machine by determining the leaving of the autonomous mobile machine functioning as a base station according to the operation state.

(7) The management system according to (4),
in which the operation plan creation unit determines the leaving of the first autonomous mobile machine based on whether there is a change in the operation schedule of the first autonomous mobile machine during the first predetermined period.

According to (7), it is possible to effectively utilize the autonomous mobile machine by determining the leaving of the autonomous mobile machine functioning as a base station according to the change in the operation schedule.

(8) The management system according to any one of (4) to (7),
in which the operation plan creation unit creates the operation plan such that the second autonomous mobile machine stands still at a same position as the predetermined geographical position when the predetermined geographical position satisfies a first condition related to a surrounding environment.

According to (8), when a standstill place of the first autonomous mobile machine is suitable for arrangement of a base station, the second autonomous mobile machine is arranged at the same position, so that the positioning can be continued with high accuracy.

(9) The management system according to (8),
in which the first condition includes at least one of a condition regarding an elevation angle between an object around the predetermined geographical position and the first autonomous mobile machine, a condition regarding a height of the object around the predetermined geographical position, and a condition regarding an inclination of a ground surface.

According to (9), it is possible to perform highly accurate positioning by determining the position of the autonomous mobile machine functioning as a base station based on a factor that decreases positioning accuracy.

(10) The management system according to (8) or (9),
in which the operation plan creation unit creates the operation plan such that the second autonomous mobile machine satisfies the first condition and stands still at another position different from the predetermined geographical position in response to the predetermined geographical position satisfying a second condition related to the surrounding environment or in response to the first condition being no longer satisfied.

According to (10), when a standstill place of the first autonomous mobile machine is not suitable for the arrangement of the base station, or when the standstill place of the first autonomous mobile machine is not suitable for the arrangement of the base station after the fact, the second autonomous mobile machine is arranged at a different position, so that it is possible to perform positioning with high accuracy.

(11) The management system according to (10),
in which the another position is a position where positioning data already exists.

According to (11), even when the standstill position of the second autonomous mobile machine is set to a position different from the standstill position of the first autonomous mobile machine, it is not necessary to perform the positioning statistical processing after the second autonomous mobile machine stands still when the positioning data exists, and thus it is possible to continue positioning with high accuracy.

(12) The management system according to any one of (2) to (11),
in which each of the first autonomous mobile machine and the second autonomous mobile machine includes the autonomous movement control unit, the reception unit, and a battery,
in which the reception unit and the battery constitute a detachable body (base station unit) that is detachable from a machine body, and
in which each of the first autonomous mobile machine and the second autonomous mobile machine is configured to install the detachable body at the predetermined geographical position.

According to (12), since a part functioning as a base station can be attached to and detached from the autonomous mobile machine, convenience is improved.

(13) A management method for creating an operation plan for a plurality of autonomous mobile machines (autonomous mobile machine 21) each capable of receiving a signal from a satellite in a satellite (GNSS satellite 200) positioning system, the management method including:
selecting (step S103), by a computer, as a first autonomous mobile machine, an autonomous mobile machine capable of securing an operation schedule during a first predetermined period from among the plurality of autonomous mobile machines; and
creating (step S102), by the computer, the operation plan such that the first autonomous mobile machine is moved to a predetermined geographical position and stands still for at least a part of the first predetermined period.

According to (13), since the autonomous mobile machine that is not scheduled to operate can operate as a base station, the area in which positioning can be performed can be set more flexibly. Accordingly, it is possible to perform highly accurate positioning in a wider range.

(14) A non-transitory computer-readable storage medium storing a management program for creating an operation plan for a plurality of autonomous mobile machines (autonomous mobile machine 21) each capable of receiving a signal from a satellite (GNSS satellite 200) in a satellite positioning system, the management program causing a computer to execute a process including:
selecting (step S103), as a first autonomous mobile machine, an autonomous mobile machine capable of securing an operation schedule during a first predetermined period from among the plurality of autonomous mobile machines, and
creating (step S102) the operation plan such that the first autonomous mobile machine is moved to a predetermined geographical position and stands still for at least a part of the first predetermined period.

According to (14), since the autonomous mobile machine that is not scheduled to operate can operate as a base station, the area in which positioning can be performed can be set more flexibly. Accordingly, it is possible to perform highly accurate positioning in a wider range.

The management system according to any one of (1) to (12),
in which each of the plurality of autonomous mobile machines includes a communication unit (wireless communication interface 213) capable of transmitting and receiving a signal related to positioning (correction signal SG1, SG2).

What is claimed is:

1. A management system comprising:
a plurality of autonomous mobile machines; and
an information processing device,
wherein each of the plurality of autonomous mobile machines includes
an autonomous movement control unit configured to control an autonomous movement, and
a reception unit configured to receive a signal from a satellite in a satellite positioning system,
wherein the information processing device includes an operation plan creation unit configured to create an operation plan for the plurality of autonomous mobile machines, and
wherein the operation plan creation unit is configured to
select, as a first autonomous mobile machine, an autonomous mobile machine capable of securing an operation schedule during a first predetermined period from among the plurality of autonomous mobile machines, and
create the operation plan such that the first autonomous mobile machine is moved to a predetermined geographical position and stands still for at least a part of the first predetermined period.

2. The management system according to claim 1,
wherein the operation plan creation unit is configured to
select, as a second autonomous mobile machine, an autonomous mobile machine capable of securing an operation schedule during a second predetermined period after start of the first predetermined period from among the plurality of autonomous mobile machines, and
create the operation plan such that the second autonomous mobile machine is moved to the predetermined geographical position.

3. The management system according to claim 2,
wherein the operation plan creation unit is configured to create the operation plan such that the second autonomous mobile machine is moved to the predetermined geographical position and stands still for at least a part of the second predetermined period.

4. The management system according to claim 2,
wherein the operation plan creation unit creates the operation plan such that the second autonomous mobile machine is moved to the predetermined geographical position and the first autonomous mobile machine makes leaving from the predetermined geographical position.

5. The management system according to claim 4,
wherein the operation plan creation unit determines the leaving of the first autonomous mobile machine based on a remaining battery level of the first autonomous mobile machine.

6. The management system according to claim 4,
wherein the operation plan creation unit determines the leaving of the first autonomous mobile machine based on an operation state of the first autonomous mobile machine.

7. The management system according to claim 4,
wherein the operation plan creation unit determines the leaving of the first autonomous mobile machine based on whether there is a change in the operation schedule of the first autonomous mobile machine during the first predetermined period.

8. The management system according to claim 4,
wherein the operation plan creation unit creates the operation plan such that the second autonomous mobile machine stands still at a same position as the predetermined geographical position when the predetermined geographical position satisfies a first condition related to a surrounding environment.

9. The management system according to claim 8,
wherein the first condition includes at least one of a condition regarding an elevation angle between an object around the predetermined geographical position and the first autonomous mobile machine, a condition regarding a height of the object around the predetermined geographical position, and a condition regarding an inclination of a ground surface.

10. The management system according to claim 8,
wherein the operation plan creation unit creates the operation plan such that the second autonomous mobile machine satisfies the first condition and stands still at another position different from the predetermined geographical position in response to the predetermined geographical position satisfying a second condition related to the surrounding environment or in response to the first condition being no longer satisfied.

11. The management system according to claim 10,
wherein the another position is a position where positioning data already exists.

12. The management system according to claim 2,
wherein each of the first autonomous mobile machine and the second autonomous mobile machine includes the autonomous movement control unit, the reception unit, and a battery,
wherein the reception unit and the battery constitute a detachable body that is detachable from a machine body, and
wherein each of the first autonomous mobile machine and the second autonomous mobile machine is configured to install the detachable body at the predetermined geographical position.

13. A management method for creating an operation plan for a plurality of autonomous mobile machines each capable of receiving a signal from a satellite in a satellite positioning system, the management method comprising:
selecting, by a computer, as a first autonomous mobile machine, an autonomous mobile machine capable of securing an operation schedule during a first predetermined period from among the plurality of autonomous mobile machines; and
creating, by the computer, the operation plan such that the first autonomous mobile machine is moved to a predetermined geographical position and stands still for at least a part of the first predetermined period.

14. A non-transitory computer-readable storage medium storing a management program for creating an operation plan for a plurality of autonomous mobile machines each capable of receiving a signal from a satellite in a satellite positioning system, the management program causing a computer to execute a process comprising:
selecting, as a first autonomous mobile machine, an autonomous mobile machine capable of securing an operation schedule during a first predetermined period from among the plurality of autonomous mobile machines, and
creating the operation plan such that the first autonomous mobile machine is moved to a predetermined geographical position and stands still for at least a part of the first predetermined period.
